(19) United States
(12) Patent Application Publication
(10) Pub. No.: US 2003/0126792 A1
(43) Pub. Date: Jul. 10, 2003

(54) Mechanical barrier to block the growth of plant and tree roots

(75) Inventor: Richard Auger, St-Elzear (CA)

Correspondence Address: ROBIC, 55 St Jacques, Montreal, QC, H2Y 3X2, CA

(73) Assignee: TEXEL INC.

(21) Appl. No.: 10/192,793

(22) Filed: Jul. 11, 2002

(30) Foreign Application Priority Data
Jan. 7, 2002 (CA) 2,366,028

(51) Int. Cl. A01G 9/00

(52) U.S. Cl. 47/32

(57) ABSTRACT

A water permeable membrane capable of blocking the growth of plant and tree roots only in a mechanical way. This membrane comprises n layers of a non-woven material having a predetermined thickness and n+1 layers of an impermeable material perforated with holes to allow drainage of water, where n is an integer equal or greater than 1. The layers of non woven and impermeable material are in alternate position so that two layers of impermeable material form external layers of the water permeable membrane, and each layer of non-woven material is positioned between two layers of the impermeable material.

### FIELD OF THE INVENTION

The present invention relates to a water permeable membrane intended to be used as a barrier to protect underground works from the destructive action of plant and tree roots. This type of barrier is preferably installed vertically in the ground, in order to prevent roots from crossing from one side of the membrane to the other.

### BACKGROUND OF THE INVENTION

There are many kinds of barriers which are used to block the growth of plant and tree roots. Such barriers are useful to protect underground works from the destructive effects of roots.

These barriers are divided into two main categories: mechanical barriers and chemical barriers. FIG. 1 shows the various types of barriers known to control the growth of roots.

The known mechanical barriers used to stop the growth of tree and plant roots are of two types: the impermeable one and the permeable one.

The mechanical barriers of the impermeable type usually consist of PVC membranes or membranes of polyethylene of high density (HDPE). These membranes are extremely effective to block root growth. However, their use is not widespread for various reasons:

first of all, these types of products are heavy and difficult to install;

secondly, their impermeability creates drainage and stability problems when they are installed vertically on inclines; and

finally, such membranes are expensive.

U.S. Pat. No. 5,070,642 (ALBRECHT), U.S. Pat. No. 5,528,857 (ALBRECHT and al), U.S. Pat. No. 5,305,549 (ALBRECHT), U.S. Pat. No. 5,383,302 (HILL) and U.S. Pat. No. 5,442,891 (ALBRECHT) show how it is possible to change the direction of root growth. This change in direction is done by guiding the roots with the help of devices of particular geometry as described in these patents. These devices permit to divert the roots without stopping their growth. In general, these devices are expensive, because they are produced by moulding and must be assembled from separate pieces. It is not possible also in every case, to position these devices in the desired way.

In the case of permeable mechanical barriers, the capacity of preventing root growth is, in general, much less efficient than with the impermeable barriers. U.S. Pat. No. 4,574,422 (REIGER et al.) and U.S. Pat. No. 4,884,367 (LAWTON) disclose methods for partially preventing the passage of tree roots by means of bags made of non-woven material. These bags are used in the field of tree growing. Each bag is laid out around the root system of a tree during transplantation. The construction of such a bag of non-woven material is such that the roots have difficulty crossing the bag. Thus, to some extent, the bag acts as a filter.

This kind of barriers is intended to allow the development of a root system which is not in a “spiral” state, viz. not wrapped around itself. The roots that do manage to cross the bag are of a much smaller diameter than those which would be present in the absence of the bag. As the roots are easier to cut, the harvest of trees is facilitated and the shock caused to the tree by the amputation of part of its root system is reduced.

The use of such a barrier is not appropriate for long-term uses. Indeed, to achieve such a goal, it would be necessary to have bag built with a much greater thickness of non-woven material. Such a thickness would be physically difficult to obtain and the cost would be prohibitive.

The other major category of root barriers consists of generally permeable membranes which contain an active chemical agent. U.S. Pat. No. 5,116,414 (BURTON et al.) and U.S. Pat. No. 5,449,250 (BURTON et al.) disclose the use of an herbicide called “trifluralin” to stop root growth. Similarly, U.S. Pat. No. 5,575,112 (SCHEUBEL) teaches the use of a copper compound added to a non-woven material to form a barrier which stops root growth.

These barriers are capable of stopping tree roots as long as the active agent is present. However, as the active agent is slowly released in the environment, the capacity of these barriers to stop root growth decreases over the time. The installation of these barriers can also be prohibited in certain types of environments and may require licenses for their installation as well as specialists to do it.

### SUMMARY OF THE INVENTION

An object of the present invention is to provide a membrane devised to create a barrier for blocking the growth of plant and tree roots without the use of active chemical agents.

More precisely, the object of the invention is to provide a water permeable membrane capable of blocking the growth of tree and plant roots only in a mechanical way, which comprises:

n layers of a non-woven material having a predetermined thickness; and

n+1 layers of an impermeable material perforated with holes to allow the drainage of water;

where n is an integer equal or greater than 1.

These layers of a non-woven material and of an impermeable material are in alternate position so that two of said layers of an impermeable material form external layers of the water permeable membrane, and each layer of a non-woven material is positioned between two of the layers of an impermeable material.

Each of the layers of a non-woven material preferably has its opposite surfaces bound to the adjacent layers of impermeable material.

The membrane according to the invention can comprise a great number of layers, as long as the following formula is respected:

n+1 impermeable layers+n layers of a non-woven material=membrane,

where n is an integer equal or greater than 1.

The membrane according to the invention permits to stop tree roots without using active agents. Moreover, it has some permeability to water. Due to its structure, the membrane forces the roots to undertake, through the layers of non-woven material, a trajectory longer than what is normally the case. Thus, it is possible to simulate a thickness as layer as desired by using a non-woven material of a predetermined thickness. In this manner, the layer(s) of non-woven material are, to some extent, capable of stopping the tree roots.

The membrane preferably consists of two perforated impermeable sheets placed on both side of a non-woven material. Preferably, the relative position of the holes of one of the sheets with respect to the other is selected so that, when the membrane is assembled, the distance necessary to travel from one side of the membrane to the other is maximized.

The invention and its operation will be better understood upon reading the following non-restrictive detailed description of the invention and example, made with reference to the accompanying drawings.

### BRIEF DESCRIPTION OF THE DRAWINGS

FIG. 1 is a diagram summarizing the various types of barriers presently used to control the growth of roots.

FIG. 2 is an exploded perspective view of a membrane according to a preferred embodiment of the invention.

FIG. 3 is a perspective view of the membrane shown in FIG. 2, after it has been assembled.

FIG. 4 is a perspective view in partial cross-section of the membrane illustrated in FIG. 3, showing, with the help of arrows, the distance the roots must be travel to cross from one side of the membrane to the other.

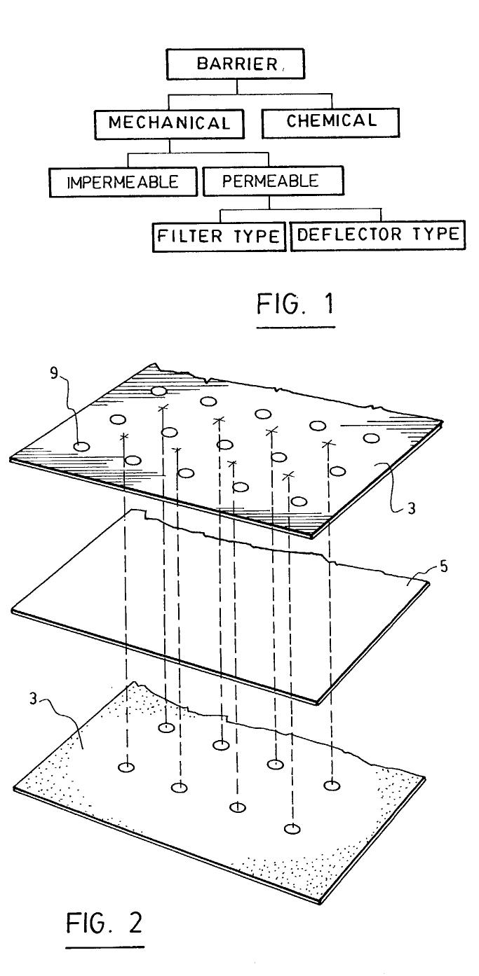

### DESCRIPTION OF PREFERRED EMBODIMENTS OF THE INVENTION

The membrane (1) according to the preferred embodiment of the invention as illustrated in FIGS. 2 to 4, comprises two perforated layers of impermeable material in the form of two plastic sheets plastic sheets (3) located on both sides of a layer of a non-woven material in the form of another sheet (5). The two perforated plastic sheets (3) are bound to the corresponding sides of the non-woven material sheet (5) preferably with an adhesive.

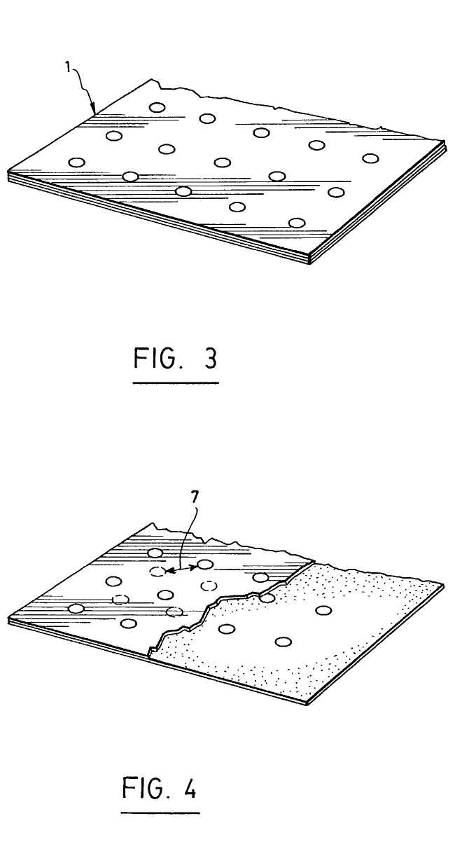

When the membrane (1) is assembled as shown in FIG. 3, it becomes possible to handle it like any other known membrane, i.e. to roll it, to fold it, to cut it in sheets of desired form and dimensions, to sew it or to stick it. It is thus possible to use it like a barrier, to make bags with it or to give it any other possible form that a membrane can have.

FIG. 4 illustrates in a simple manner, the way the membrane (1) operates. The holes (9) pierced in the layers of the impermeable material, viz. the plastic sheets (3) are laid out in a predetermined pattern in order to be alternate the position of the holes (9) of one layer with those of the other layer. The sheet of non-woven material is not shown in FIG. 4 to make it possible to clearly see the position of the holes (9). Thus, a root which penetrates in the non-woven material (5) via one of the sides of the membrane (1) is forced to “travel” the distance indicated by the arrow (7) before coming out on the other side of the membrane (1). The distance indicated by the arrow (7) is much greater than the thickness of the sheet non-woven material (5).

Thus, passage of roots is prevented by the membrane (1) according to the invention, even though the membrane (1) still allows drainage of water.

It is obvious that the spacing between the holes (9) and the position of the holes (9) can vary depending on the user's needs. Indeed, the holes are laid out in a predetermined pattern which may vary from one use to the other. It is also possible to superimpose the layers of the membrane (1) according to the following diagram:

{(perforated plastic sheet (3)+non-woven (5))ₙ+perforated plastic sheet (3)}

where n is an integer equal or greater to 1,

in order to increase the distance the roots must travel to pass through the membrane (1) from one side to the other.

Preferably, the layer of non-woven material (5) of the membrane (1) according to the present invention consists of fibers of one or more polymers selected from the group consisting of polyester, polypropylene, polyethylene, nylon, acrylic and combinations thereof.

The plastic sheets (3) forming the layers of impermeable material can be made of any kind of known polymer or plastic or any other material having similar characteristics. Preferably, the impermeable membrane is selected from the group consisting of: polyester, polypropylene, polyethylene, nylon, acrylic and combinations thereof.

Other characteristics of the invention lie in that:

the layer of non-woven material (5) are made of fibers of a material which is preferably capable of resisting biological breakdown and water;

the layer of impermeable material are made of a material, which is preferably capable of resisting biological breakdown and water; and

the relative position of the holes (9) perforated in the layers of impermeable material located on both sides of the layer(s) of non-woven material is preferably selected to maximize the distance that a root must travel through the layer of non-woven material and thus through the membrane, to get from one side of the membrane to the other, so that this distance is much greater than the total thickness of the non-woven material (5).

Of course, the type of glue or adhesive used to assemble the membrane is not limited to the one disclosed in the following example. It may actually be selected amongst any kind of adhesives or binders which allows to obtain a similar result. Moreover, the membrane according to the present invention may also be assembled by welding the different layers of material together.

In another preferred embodiment of the invention, the layers of impermeable material are applied onto the non-woven material in a liquid form, and then allowed to harden to form impermeable sheets. This method of applying the impermeable material onto the non-woven material is called “coating”.

### EXAMPLE

As an example, two polyethylene sheets of a thickness of 0.5 mm were glued to a sheet of non-woven material made of polyester fibers with the help of a rolling mill. The holes on these sheets had a diameter of 10 mm and were laid out regularly 4 cm away from each other.

The sheets were glued together by applying a layer of 8 g/m² of thermofusible vinyl acetate adhesive on the sheet of non-woven material, which had a surface mass of 135 g/m². The so assembled sheets where thermally bonded within a calender. The final thickness of the non-woven material was approximately 0.8 mm.

Of course, numeral modifications can be brought to the invention described previously without departing from the spirit and the scope of the present invention.

1. A water permeable membrane capable of blocking the growth of tree and plant roots only in a mechanical way, comprising:
n layers of a non-woven material having a predetermined thickness; and
n+1 layers of an impermeable material pierced with holes to allow drainage of water;
where n is an integer equal to or greater than 1;
said layers of a non-woven material and of an impermeable material being in alternate position so that two of said layers of an impermeable material form external layers of the water permeable membrane, and each layer of a non-woven material is positioned between two of said layers of an impermeable material.

2. A membrane according to claim 1, wherein the non-woven material is made of fibers of a material capable of resisting to biological breakdown and water.

3. A membrane according to claim 2, wherein the fibers are made in a material selected from the group consisting of polyester, polypropylene, polyethylene, nylon, acrylic and combinations thereof.

4. A membrane according to claim 1, wherein the impermeable material consists of a material capable of resisting a biological breakdown and water.

5. A membrane according to claim 4, wherein the impermeable material is selected from the group consisting of polyester, polypropylene, polyethylene, nylon, acrylic and combinations thereof.

6. A membrane according to claim 1, wherein the holes are laid out in a predetermined pattern on the impermeable material.

7. A membrane according to claim 1, wherein each of said layers of a non-woven material has opposite surfaces which are both bound to the adjacent layers of an impermeable material.

8. A membrane according to claim 7, wherein the surfaces of said layers of a non-woven material are bound to the adjacent layers of an impermeable material by means of an adhesive or by welding.

9. A membrane according to claim 7, wherein said layers of a impermeable material are applied onto the adjacent layers of a non-woven material by coating.

10. A membrane according to claim 1, wherein the layers of an impermeable material located on both sides of said at least one layer of a non-woven material are placed so that the holes of each of said layers of an impermeable material be positioned to maximize the distance a root must grow to go from one side of the membrane to the other.

11. A membrane according to claim 3, wherein the impermeable material is selected from the group consisting of polyester, polypropylene, polyethylene, nylon, acrylic, and combinations thereof.

12. A membrane according to claim 11, wherein each of said layers of a non-woven material has opposite surfaces which are both bound to the adjacent layers of an impermeable material.

13. A membrane according to claim 12, wherein the layers of an impermeable material located on both sides of said at least one layer of a non-woven material are placed so that the holes of each of said layers of an impermeable material be positioned to maximize the distance a root must grow to go from one side of the membrane to the other.
